(19) United States
(12) Patent Application Publication
(10) Pub. No.: US 2025/0038229 A1
(43) Pub. Date: Jan. 30, 2025

(54) METHOD FOR OPERATING A FUEL CELL SYSTEM, AND FUEL CELL SYSTEM

(71) Applicant: Robert Bosch GmbH, Stuttgart (DE)

(72) Inventor: Helerson Kemmer, Vaihingen (DE)

(21) Appl. No.: 18/716,313

(22) PCT Filed: Dec. 5, 2022
(86) PCT No.: PCT/EP2022/084346

§ 371 Date: Jun. 4, 2024

(30) Foreign Application Priority Data
Dec. 20, 2021 (DE) 10 2021 214 689.9

(51) Int. Cl. H01M 8/04089; H01M 8/04082; H01M 8/04111; H01M 8/04223

(52) U.S. Cl. CPC H01M 8/04097; H01M 8/04111; H01M 8/04201; H01M 8/04231

(57) ABSTRACT

The invention relates to a method for operating a fuel cell system (1) comprising at least one fuel cell stack (100) having a cathode (110) and an anode (120), wherein, during normal operation of the fuel cell system (1), the cathode (110) is supplied with air via a supply air path (111), and exhaust air exiting the fuel cell stack (100) is discharged via an exhaust air path (112), and wherein the anode (120) is supplied with hydrogen via an anode circuit (121). According to the invention, in order to create a passivation layer of the anode (120) and/or for the repassivation of a passivation layer of the anode (120), periodically, exhaust air is branched off from the exhaust air path (112) or an exhaust air path (212) of another fuel cell stack (200) and introduced into the anode circuit (121) of the anode (120).

The invention also relates to a fuel cell system (1) for carrying out a method according to the invention.

### BACKGROUND

The invention relates to a method for operating a fuel cell system. The invention further relates to a fuel cell system suitable for performing the method according to the invention or for operation according to the method.

Preferred areas of application are fuel cell vehicles, preferably fuel cell vehicles with start-stop operation.

Fuel cells are electrochemical energy converters. In particular, hydrogen (H₂) and oxygen (O₂) can be used as reaction gases. These are converted into electrical energy, water (H₂O) and heat with the aid of a fuel cell. The core of a fuel cell is a membrane electrode assembly (MEA), which comprises a membrane coated on both sides with a catalytic material to form electrodes. During operation of the fuel cell, one electrode, the anode, is supplied with hydrogen and the other electrode, the cathode, is supplied with oxygen.

In practice, a large number of fuel cells are connected to form a fuel cell stack in order to increase the electrical output. In addition, multiple fuel cell stacks or fuel cell systems can be interconnected.

During normal operation of a fuel cell system, no oxygen is supplied to the anode of a fuel cell stack. When shutting down or shutting down the fuel cell stack, the same is sought to prevent degradation of the fuel cells. However, the absence of oxygen in the anode leads to the removal of a passivation layer on the anode surfaces, which in turn results in an increase in susceptibility to corrosion.

### SUMMARY

The present invention is concerned with the task of reducing the susceptibility of anode surfaces to corrosion by targeted passivation or repassivation. This is intended to increase the service life of the anode components.

In order to solve this problem, the method having the features of the disclosure is proposed. In addition, a fuel cell system is specified which is suitable for carrying out the method or can be operated according to the method.

A method for operating a fuel cell system with at least one fuel cell stack comprising a cathode and an anode is proposed. During normal operation of the fuel cell system, air is supplied to the cathode via a supply air path and exhaust air exiting the fuel cell stack is discharged via an exhaust air path. The anode is supplied with hydrogen via an anode circuit. According to the invention, to build up a passivation layer of the anode and/or to repassivate a passivation layer of the anode, exhaust air from the exhaust air path or an exhaust air path of another fuel cell stack is branched off periodically and introduced into the anode circuit of the anode.

As the exhaust gas from a fuel cell stack generally has a very low oxygen concentration, it can be introduced to the anode circuit and used to passivate or repassivate the anode surfaces. This makes it easy to counteract the degradation of a passivation layer during shutdown phases. If the fuel cell system comprises only one fuel cell stack, only one exhaust air path is available from which the exhaust air required for passivation or repassivation can be branched off. If the fuel cell system comprises several fuel cell stacks, the exhaust air from another fuel cell stack can also be used for passivation or repassivation.

Building up or maintaining the passivation layer reduces the risk of corrosion and therefore increases the service life of the fuel cell stack, especially the electrochemical layers made of catalytic material. This is because, among other things, the migration of metal ions into the membrane is reduced.

If the required exhaust air branches off from the exhaust air path of the same fuel cell stack, it is preferably introduced via a purge valve and/or drain valve integrated into the anode circuit, which is connected to the exhaust air path of the same fuel cell stack via a connecting line. Since a purge valve and/or drain valve is or are regularly present, which are also regularly connected to the exhaust air path via a connection line, existing components can be used to carry out the method. In this case, the method is completely system-neutral, as no additional components are required. As the connection line is usually used to introduce a purge volume discharged via the purge valve and/or drain valve into the exhaust air path in order to dilute it, only the flow direction in the connection line needs to be temporarily reversed.

To reverse the direction of flow, it is suggested that the supply pressure in the exhaust air path is temporarily increased compared to the pressure in the anode circuit, for example by 20 mbar. Due to the pressure difference, exhaust air then flows from the exhaust air path into the anode circuit when the purge and/or drain valve is open.

If the required exhaust air branches off from the exhaust air path of another fuel cell stack, it is preferably introduced to the anode circuit of the first fuel cell stack via a separate connecting line with an integrated shut-off valve. This means that at least one additional connecting line and one additional valve are provided to connect the anode circuit of a first fuel cell stack with the exhaust air path of another fuel cell stack. The separate connection line has the advantage that there is no need for a temporary increase in pressure in the exhaust air path compared to the pressure in the anode circuit of the same fuel cell stack. As the pressure differences in the cell membranes can also change with the pressure increase, which can lead to fatigue and failure of the membrane material in the long term, using the exhaust air from another fuel cell stack is an improvement over using the cell's own exhaust air.

If the fuel cell system comprises several fuel cell stacks, each anode circuit of a fuel cell stack can be connected to the exhaust air path of another fuel cell stack via a separate connecting line with an integrated shut-off valve. In this way, the anode surfaces of all fuel cell stacks can be passivated or repassivated periodically with the exhaust air from the other fuel cell stack. The number of additional connection lines and valves then preferably corresponds to the number of fuel cell stacks.

Furthermore, it is proposed that in a fuel cell system with several fuel cell stacks, the overall pressure level of the additional fuel cell stack is temporarily raised compared to that of the first fuel cell stack. In contrast to the previously described increase in pressure in the exhaust air path compared to the pressure in the anode circuit of the same fuel cell stack, the pressures on the cathode side and the anode side always remain coupled with each other, so that damaging pressure differences cannot occur in the cell membranes. Temporarily raising the overall pressure level of the other fuel cell stack ensures that exhaust air flows from its exhaust air path into the anode circuit of the connected fuel cell stack when the shut-off valve integrated in the connecting line is opened.

Another preferred method for passivation or repassivation is to temporarily reduce the oxygen concentration of the exhaust air in the exhaust air path. This applies in each case to the exhaust air path from which the exhaust air required for passivation or repassivation branches off, regardless of whether it is the exhaust air path of the same or another fuel cell stack. The effectiveness of the method can be further increased by reducing the oxygen concentration.

Reducing the oxygen concentration can be achieved in various ways, for example by reducing the air stoichiometry, by increasing the flow without adjusting the air supply and/or by increasing the exhaust air recirculation rate.

As an additional measure, it is proposed that a fan integrated into the anode circuit be operated while the exhaust air is being fed into the anode circuit. The fan can be used to intensify the circulation of the exhaust air introduced into the anode circuit so that it is better distributed throughout the anode circuit. In particular, the fan can be a recirculation fan, which is used to recirculate anode gas exiting the fuel cell stack in the anode circuit during normal operation of the system.

In addition, a fuel cell system with several fuel cell stacks is proposed to solve the above-mentioned problem. The fuel cell stacks of the fuel cell system each have a cathode and an anode, wherein the cathodes are each connected to a supply air path on the inlet side and to an exhaust air path on the outlet side. The anodes are each connected to an anode circuit. According to the invention, the exhaust air path of at least one fuel cell stack can be connected to the anode circuit of another fuel cell stack via a separate connecting line with an integrated shut-off valve.

The proposed fuel cell system is therefore suitable for carrying out the method or can be operated according to the method, so that the same advantages can be achieved. In particular, the anode surfaces of at least one fuel cell stack can be passivated or repassivated using the exhaust air from another fuel cell stack. As a result, the service life of the fuel cell stack is increased.

Ideally, each fuel cell stack of the fuel cell system has an anode circuit that is connected to an exhaust air path of another fuel cell stack via a separate connecting line with an integrated shut-off valve in order to be able to passivate or repassivate the anode surfaces with the aid of the exhaust air from the other fuel cell stack. The service life of all fuel cell stacks can be increased accordingly.

### BRIEF DESCRIPTION OF THE DRAWINGS

A preferred embodiment of the invention is explained in more detail below with reference to the accompanying drawings. Shown are:

FIG. 1 a schematic representation of a fuel cell system,

FIG. 2 the sequence of a method according to the invention, according to which the fuel cell system of FIG. 1 can be operated,

FIG. 3 a schematic representation of a further fuel cell system according to the invention and

FIG. 4 the sequence of a method according to the invention, according to which the fuel cell system of FIG. 3 can be operated.

### DETAILED DESCRIPTION

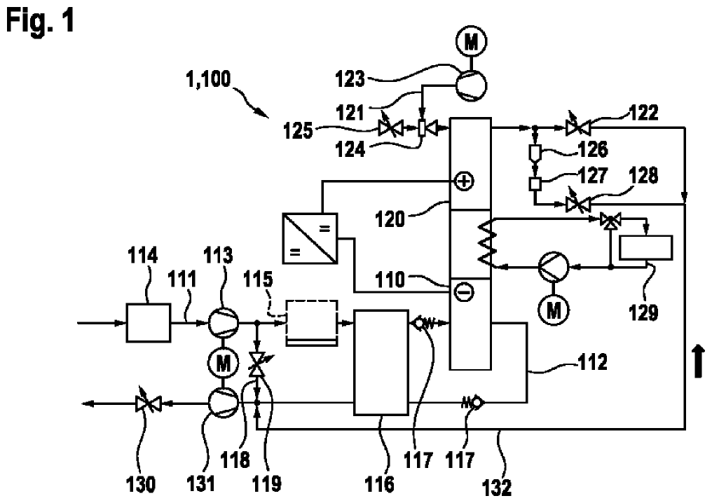

FIG. 1 shows a first fuel cell system 1 which is suitable for carrying out a method according to the invention or can be operated according to such a method. The fuel cell system 1 of FIG. 1 comprises a fuel cell stack 100 with a cathode 110 and an anode 120. The cathode 110 is supplied with air as an oxygen supplier via a supply air path 111. The air is taken from the surroundings and first supplied to an air filter 114. It is then compressed with the aid of an air conveying and air compression system 113. As the air heats up during compression, it is cooled with the aid of a heat exchanger 115 integrated into the supply air path 111 and, if necessary, humidified with the aid of a humidifier 116 also integrated into the supply air path 111. However, the heat exchanger 115 and/or the humidifier 116 are not absolutely necessary. On the outlet side, the fuel cell stack 100 is connected to an exhaust air path 112, which leads through the humidifier 116, so that the humid exhaust air can be used to humidify the supply air. Downstream of the humidifier 116, the exhaust air is supplied to a turbine 131 of the air conveying and air compression system 113, with the aid of which some of the energy previously used for compression can be recovered. The exhaust air is discharged from the exhaust air path 112 via a pressure control valve 130 arranged downstream of the turbine 131. A bypass path 118 and a bypass valve 119 are provided to bypass the fuel cell stack 100. The supply air path 111 can be connected to the exhaust air path 112 via the bypass path 118 and the bypass valve 119. To prevent the air from flowing back, a non-return valve 117 is integrated into both the supply air path 111 and the exhaust air path 112.

The anode 120 of the fuel cell stack 100 is supplied with an anode gas via an anode circuit 121. This can be hydrogen in particular. Since the anode gas exiting the fuel cell stack 100 generally still contains hydrogen, the anode gas is recirculated via the anode circuit 121, passively with the aid of a jet pump 124 and actively with the aid of a fan 123. As recirculated anode gas is enriched with nitrogen over time, the anode circuit 121 is purged periodically. For this purpose, a purge valve 122 is integrated into the anode circuit 121, which is connected to the exhaust air path 112 via a connecting line 132, so that the purge volume can be introduced into the exhaust air path 112. In the exhaust air path 112, the purge volume, which may still contain hydrogen, mixes with the exhaust air so that a dilution is achieved that prevents an explosive gas mixture from forming. Water produced during operation of the fuel cell stack 100 can be separated by means of a water separator 126 integrated in the anode circuit 121 and collected in a container 127. The container 127 can be emptied as required by opening a drain valve 128. Emptying takes place in the connection line 132, as anode gas can also escape with the water. The heat that is also generated during operation is dissipated with the aid of a cooling circuit 129.

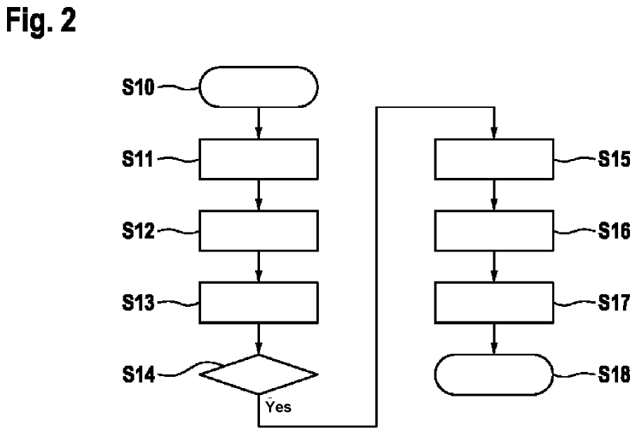

The fuel cell system 1 shown in FIG. 1 can be operated according to the method shown in FIG. 2, which is described below. The method is used to build up a passivation layer on the anode side or to repassivate such a layer.

In step S10, the passivation of the anode surfaces of the fuel cell stack 100 is initiated. In the subsequent step S11, the pressure in the exhaust air path 112, namely upstream of the turbine 131, is raised slightly compared to the pressure in the anode circuit 121, so that a pressure difference of 20 mbar, for example, is achieved. In step S12, which is optional, the oxygen concentration of the exhaust air in the exhaust air path 112 is reduced. Subsequently, in step S13, the purge valve 122 and/or the drain valve 128 is/are opened. Due to the pressure difference between the pressure in the exhaust air path 112 and the pressure in the anode circuit 121, exhaust air then flows in the opposite direction of flow (see arrow in FIG. 1) from the exhaust air path 112 via the connecting line 132 into the anode circuit 121. In step S14, it is checked whether a certain passivation quantity and/or passivation time, for example 2 seconds, has/have been reached. If the result of the test is positive (“yes”), the purge valve 122 and/or the drain valve 128 can be closed again in step S15. Furthermore, in step S16, the oxygen concentration in the exhaust air path 112 can be raised to a normal level again, provided that step S12 has been carried out. In step S17, the previously set pressure difference between the pressure in the exhaust air path 112 and the pressure in the anode circuit 121 is also canceled. The method is then ended in step S18.

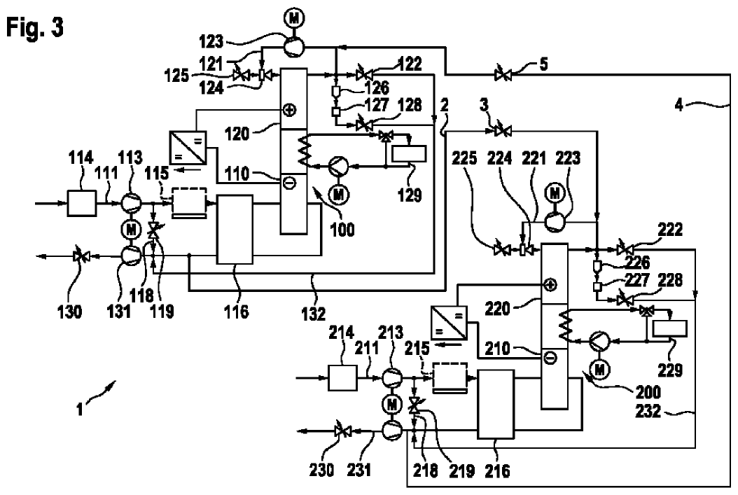

A further development of the invention can be achieved with the aid of a fuel cell system 1 comprising a plurality of fuel cell stacks 100, 200. An example of such a fuel cell system 1 is shown in FIG. 3.

FIG. 3 shows a fuel cell system 1 according to the invention with a first fuel cell stack 100 and a second fuel cell stack 200. The fuel cell stacks 100, 200 each have a cathode 110, 210 and an anode 120, 220. The cathodes 110, 210 are each supplied with air as an oxygen supplier via a supply air path 111, 211. The air is taken from the surroundings and supplied via an air filter 114, 214 to an air conveying and air compression system 113, 213 to provide a certain air mass flow and a certain pressure level. As the air heats up, it is cooled with the aid of a heat exchanger 115, 215 integrated into the supply air path 111, 211 and humidified with the aid of a humidifier 116, 216. The exhaust air from the fuel cell stacks 100, 200 is discharged via an exhaust air path 112, 212. A turbine 131, 231 for energy recovery and a pressure control valve 130, 230 are integrated into the exhaust air path 112, 212. To bypass the fuel cell stacks 100, 200, the supply air paths 111, 211 and the exhaust air paths 112, 212 can each be connected via a bypass path 118, 218 with integrated bypass valve 119, 219.

The anodes 120, 220 of the two fuel cell stacks 100, 200 are each supplied with fresh anode gas or hydrogen and with recirculated anode gas via an anode circuit 121, 221. Recirculation is achieved passively with the aid of a jet pump 124, 224 and actively with the aid of a fan 123, 223. Since the recirculated anode gas is enriched with nitrogen over time, which diffuses from the cathode side to the anode side, a purge valve 122, 222 is provided in each of the anode circuits 121, 221. By opening the purge valve 122, 222, nitrogen-containing anode gas is discharged from the anode circuit 121, 221 and introduced via a connecting line 132, 232 into the respective exhaust air path 112, 212 for dilution. Since the recirculated anode gas is also enriched with water, a water separator 126, 226 with a container 127, 227 is also integrated in each of the anode circuits 121, 221. The container 127, 227 can be emptied periodically by opening a drain valve 128, 228.

The heat generated during operation of the fuel cell stacks 100, 200 is dissipated by means of a cooling circuit 129, 229.

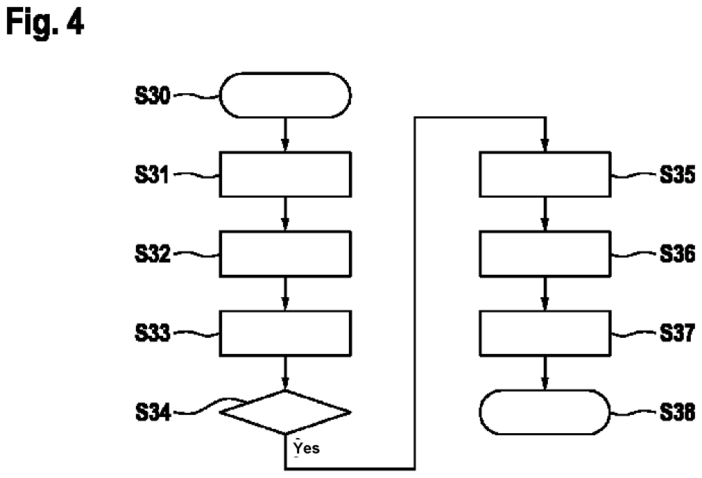

The anode circuits 121, 221 of the two fuel cell stacks 100, 200 are each connected or connectable to the exhaust air path 212, 112 of the respective other fuel cell stack 200, 100 via a separate connecting line 2, 4 with integrated shut-off valve 3, 5. To passivate or repassivate the anode surfaces, the shut-off valves 3, 5 can then be opened in sequence and the exhaust air from the exhaust air path 112, 212 of one fuel cell stack 100, 200 can be introduced into the anode circuit 221, 121 of the other fuel cell stack 200, 100 via the respective connecting line 2, 4. In detail, the steps of the method shown in FIG. 4, which is described below, can be carried out.

In step S30, the passivation of the anode surfaces of the anode 220 of the fuel cell stack 200 is initiated. For this purpose, in step S31, the total pressure level in the fuel cell stack 100 is first raised above the total pressure level in the fuel cell stack 200, so that the pressure in the exhaust air path 112 upstream of the turbine 131 is above the pressure in the anode circuit 221 of the fuel cell stack 200. In an optional step S32, the oxygen concentration of the exhaust air in the exhaust air path 112 can also be reduced. The shut-off valve 3 is then opened in step S33, so that exhaust air from the exhaust air path 112 flows into the anode circuit 221 of the fuel cell stack 200 via the connecting line 2 due to the pressure difference. Step S34 then checks whether a certain passivation quantity or passivation time, for example 2 seconds, has been reached. If the result of the test is positive (“yes”), the shut-off valve 3 can be closed again in step 35. If step S32 has been carried out, the oxygen concentration of the exhaust air in the exhaust air path 112 can be set to a normal level again in step S36. In step S37, the overall pressure level in the fuel cell stack 100 is returned to a normal level so that the method can be terminated in step S38.

In a corresponding manner, the anode surfaces of the anode 120 of the first fuel cell stack 100 can be passivated or repassivated via the connecting line 4 and the shut-off valve 5.

1. A method for operating a fuel cell system (1) comprising at least one fuel cell stack (100) having a cathode (110) and an anode (120), wherein, during normal operation of the fuel cell system (1), the cathode (110) is supplied with air via a supply air path (111), and exhaust air exiting the fuel cell stack (100) is discharged via an exhaust air path (112), and wherein the anode (120) is supplied with hydrogen via an anode circuit (121) wherein, in order to create a passivation layer of the anode (120) and/or for repassivation of a passivation layer of the anode (120), periodically, exhaust air is branched off from the exhaust air path (112) or an exhaust air path (212) of another fuel cell stack (200) and introduced into the anode circuit (121) of the anode (120).

2. The method according to claim 1, wherein that the branched-off exhaust air is introduced via a purge valve (122) and/or drain valve (128) integrated in the anode circuit (121), which is connected to the exhaust air path (112) of the same fuel cell stack (100) via a connecting line (130).

3. The method according to claim 1, wherein a pressure in the exhaust air path (112) is temporarily raised relative to a pressure in the anode circuit (121).

4. The method according to claim 1, wherein the exhaust air branched off from the exhaust air path (212) of a further fuel cell stack (200) is introduced into the anode circuit (121) of the first fuel cell stack (100) via a separate connecting line (2) with integrated shut-off valve (3).

5. The method according to claim 4, wherein an overall pressure level of the further fuel cell stack (200) is temporarily raised relative to that of the first fuel cell stack (100).

6. The method according to claim 1,
wherein an oxygen concentration of the exhaust air in the exhaust air path (112, 212) is temporarily reduced.

7. The method according to claim 1,
wherein a fan (123) integrated in the anode circuit (121) is operated during the introduction of the exhaust air into the anode circuit (121).

8. A fuel cell system (1) having a plurality of fuel cell stacks (100, 200) which each have a cathode (110, 210) and an anode (120, 220), wherein the cathodes (110, 210) each are connected on an inlet side to a supply air path (111, 211) and on an outlet side to an exhaust air path (112, 212), and wherein the anodes (120, 220) each are connected to an anode circuit (121, 221),
wherein the exhaust air path (112, 212) of at least one fuel cell stack (100, 200) can be connected to the anode circuit (221, 121) of another fuel cell stack (200, 100) via a separate connecting line (2, 4) with an integrated shut-off valve (3, 5).

9. The method according to claim 3, wherein the pressure in the exhaust air path (112) is temporarily raised by 20 mbar relative to the pressure in the anode circuit (121).
